(19) United States
(12) Patent Application Publication
(10) Pub. No.: US 2002/0111808 A1
(43) Pub. Date: Aug. 15, 2002

(54) Method and apparatus for personalizing hardware

(75) Inventor: Paul Feinberg, River Vale, NJ (US)

Correspondence Address: LERNER, DAVID, LITTENBERG,, KRUMHOLZ & MENTLIK, 600 SOUTH AVENUE WEST, WESTFIELD, NJ, 07090, US

(73) Assignee: Sony Corporation

(21) Appl. No.: 09/782,418

(22) Filed: Feb. 13, 2001

Related U.S. Application Data
(60) Provisional application No. 60/210,571, filed on Jun. 9, 2000.

(51) Int. Cl. G10L 21/00; G10L 11/00

(52) U.S. Cl. 704/270.1; 446/256

(57) ABSTRACT

A method of customizing a toy comprises receiving at a remote location information from a customizing device of a user, and transmitted to the customizing device customizing information for customizing the toy of the user and personalizing information selected based upon a personal profile, the personal profile being selected so that the toy appears familiar with the user. The toy is customized by transferring information to the toy from the customizing device and storing the information in the toy. Customizing apparatus is also disclosed.

### CROSS-REFERENCE TO RELATED APPLICATIONS

This application claims benefit of U.S. Provisional Application Serial No. 60/210,571, filed Jun. 9, 2000, the disclosure of which is hereby incorporated by reference herein

### FIELD OF THE INVENTION

The present invention relates to a method and apparatus for customizing a user's hardware.

### BACKGROUND OF THE INVENTION

Electronic devices typically provide customization in the form of presenting certain options for the user. For example, a personal computer allows a user to select the background or screen saver, from a number of options.

Video game players and other electronic toys provide users with certain options concerning the use of the video game player. Customization typically provided to a user of a video game player involves choice of games and options for playing the game, such as choice of weapons, vehicles, landscapes, courses, characters, etc.

Customization of other toys is more limited. For example, many dolls are customized by changing clothing or adding accessories. However, providing toys with electronic aspects typically adds to the size of the toy, resulting in a toy that is bulky and heavy.

A file of data can be added to a personal computer to customize the operation of the computer for the user. For example, when accessing an internet site utilizing a personal computer, a file of data may be transferred to the personal computer. The file may comprise something commonly referred to as a cookie and the data it contains is a user identification number, and possibly other information, that an internet site utilizes to determine whether a user has accessed the internet site before. The internet site can offer a user certain options in customizing the site. The internet site can use the cookie to store data concerning a user's preferences. The customization utilized is typically limited to the user's use of the personal computer on the Internet. Customization is typically directed to a few, user-chosen options which are easily re-created so that the user has not invested any substantial effort in customizing the device.

It is desirable to customize a user's device based upon the user's use of the device, over time, and to include personalization of the device so that the user grows accustomed to the particular device and has invested effort in customizing the device over time.

### SUMMARY OF THE INVENTION

The present invention is directed to these needs.

In accordance with one aspect of the present invention, a method of customizing a toy comprises receiving at a remote location user information form a customizing device of a user, and transmitting to the customizing device customizing information for customizing the toy of the user and personalizing information. The personalizing information is selected based upon a personal profile so that the toy appears familiar with the user after the user customizes the toy.

The personal profile may be generated by generating a record in a personal profile database utilizing information transmitted by the user. The record may include registration information including age, sex, and preferences such as movies, television shows, cartoon characters, books, colors, toys, name, address and billing information. The customizing information desirably includes a voice clip for producing a voice telling a story. The personalizing information desirably comprises a voice clip incorporated into the story. The personalizing information may comprise a voice clip for producing a voice commenting on personal information regarding the user as the story is told.

The customizing information and personalizing information may be assembled prior to transmitting to the customizing device. Desirably, the customizing information comprises a plurality of audio files and the personalizing information comprises an audio file and the step of assembling includes inserting the file comprising the personalizing information between predetermined files comprising customizing information. In another aspect of the present invention, a method of customizing a toy comprises transferring information from a customizing device to a toy, and storing the personalizing information in the toy. The personalizing information is selected so that the toy appears familiar with the user. The method may include connecting the customizing device to the toy. Customizing information is preferably stored at the customizing device. The customizing information preferably comprises a voice clip and the voice clip is preferably played through a speaker of the customizing device. The voice clip may be played while the customizing device is connected to the toy.

In other preferred embodiments, the customizing information is a voice clip that is played through a speaker of the toy.

Preferably, personalizing information is stored at the customizing device with the customizing information. In certain preferred embodiments, the personalizing information is stored on a storage device of the toy.

In a further aspect of the present invention, an apparatus for customizing a toy comprises a computer having a first processor under control of programs and a first program executable by said first processor and adapted to receive requests from a user's customizing device at a remote location, and transmit to the customizing device customizing information for customizing the user's toy. The first program is adapted to select and transmit to the customizing device personalizing information selected based upon a personal profile so that the toy appears familiar with the user after the user customizes the toy.

Desirably, the apparatus includes a customizing device. The customizing device preferably includes a second program executable by a second processor under control of programs. The second program may be adapted to receive the customizing information and personalizing information from the computer.

Desirably, the second program of the customizing device is adapted to transmit information to the toy. Preferably, the information transmitted to the toy comprises at least some of the customizing information and personalizing information transferred to said customizing device.

In another aspect, a customizing apparatus comprises a customizing device having a first processor under control of programs and a first storage device having a first program for requesting customizing information for customizing a toy and receiving the customizing information along with personalizing information. The apparatus includes a toy adapted to receive information form the customizing device. The personalizing information is selected based upon a personal profile so that the toy appears familiar with the user after the toy is customized.

The toy may comprise a doll. The toy may comprise a game device having a second processor under control of programs and a second storage device having a second program for running software comprising a game. The customizing information may comprise game software to be transferred to the game device. The profile may include preferences concerning game content.

### BRIEF DESCRIPTION OF THE DRAWINGS

These and other features, aspects and advantages of the present invention will become better understood with regard to the following description, appended claims and accompanying drawings where:

FIG. 1 is a schematic representation of a system for implementing a method in accordance with one embodiment of the present invention;

FIG. 2 is a rear elevational view of a toy used in the method of FIG. 1;

FIG. 3 is a schematic, rear-elevational view of a customizing device for implementing a method in accordance with the embodiment of FIGS. 1-2;

FIG. 4 is a schematic, side-elevational view of a customizing device for implementing a method in accordance with the embodiment of FIGS. 1-3;

FIG. 5 is a schematic representation of a central computer for implementing a method in accordance with the embodiment of FIGS. 1-4;

FIG. 6 is a schematic representation of a graphical interface for implementing a method in accordance with the embodiment of FIGS. 1-5;

FIG. 7 is a schematic representation of a system for implementing a method in accordance with another embodiment of the invention; and

FIG. 8 is a schematic representation of a computer system for implementing a method in accordance with a further embodiment of the invention.

### DETAILED DESCRIPTION

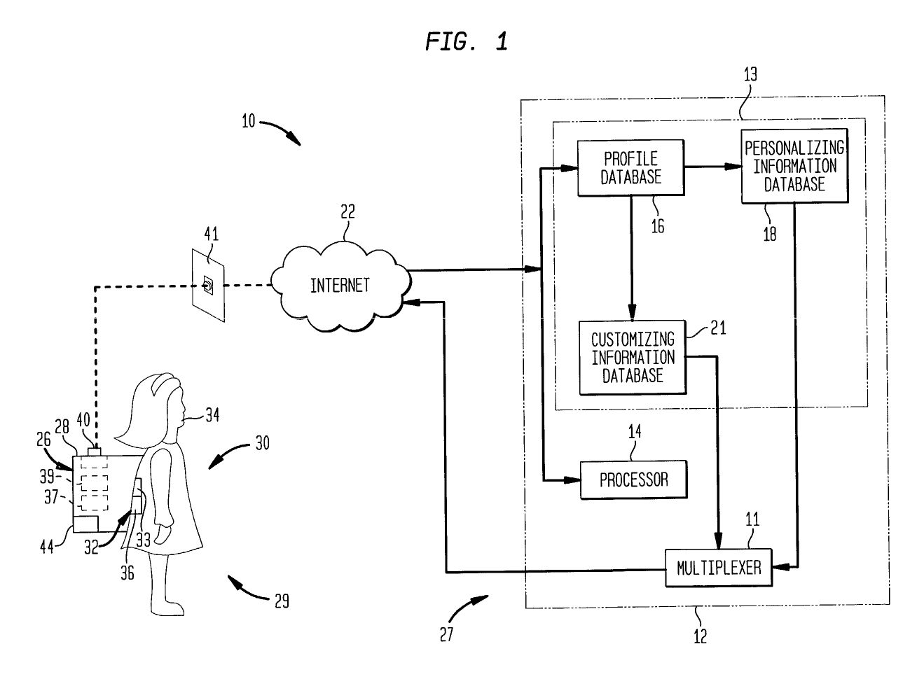

As shown in FIG. 1, a system 10 for customizing a toy of a user in accordance with an embodiment of the present invention comprises a central computer 12 having a memory storage device 13 having a database. The database may comprise a single database or a plurality of separate databases including the following: a profile database 16, a personalizing information database 18 and a customizing information database 21. These databases may be stored on separate memory storage devices or all on the same memory storage device 13. The central computer 12 has a processor 14 for controlling the operations of the central computer 12. The central computer 12 is arranged at a vendor-end 27 of the system 10 to receive requests transmitted over a network such as the internet 22 and also to transmit information over the internet 22 to users at a user-end 29 of the system 10. The central computer 12 includes a multiplexer 11 for transmitting information to the user. (See FIG. 1). The central computer 12 in FIG. 1 is operated by a vendor of toys such as dolls, board games, electronic games, toy cars and other toys.

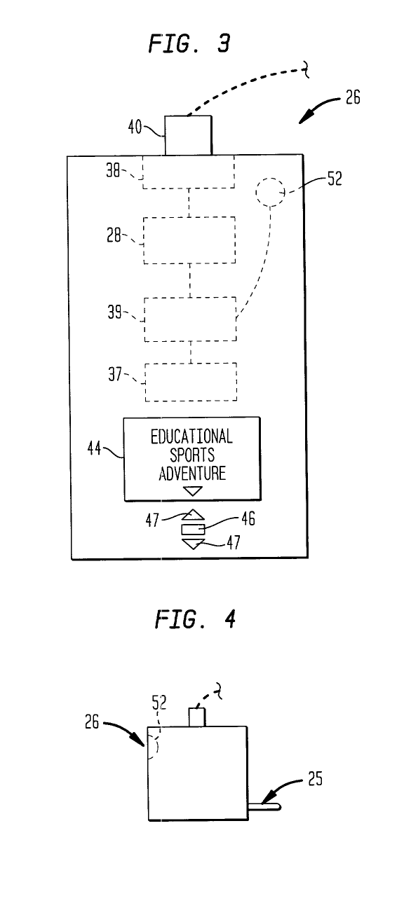

The user at the user-end 29 has a toy comprising a doll 30. (See FIG. 1). The doll 30 has a body 34 and an electronic component 32, preferably incorporated within the body 34. The electronic component 32 preferably comprises a memory storage device, such as microchip 33 for storing data that may comprise a flash memory. The doll 30 also includes a socket 36 for receiving a plug 25 of a customizing device 26 for storing data on the microchip 33, as discussed further below. A battery may be provided in the body 34 of doll 30. However, it is preferred that no battery is included. The customizing device 26 has a receptacle 38 for receiving a phone jack 40 for connecting to the internet 22. (FIG. 3). The phone jack 40 is attached to a telephone wire and is connected to a wall jack 41 for access to telephone service.

The customizing device 26 is arranged to receive customizing information for customizing the doll via the internet. The device 26 has a modem 28 for sending and receiving information over the internet 22. The device 26 includes a processor 37 which may comprise a microcontroller operatively arranged with a storage device 39 for storing information for customizing the doll 30. The receptacle 38 is operatively connected to the storage device 39. The customizing device 26 further includes an output device such as a screen 44. The screen preferably comprises a simple LCD screen. The device 26 also has a speaker 52 connected to storage device 39 for playing content received by the customizing device 26. (FIG. 1A). The customizing device includes buttons 46, 47 so that the user may select items displayed on the screen 44. The buttons may include an arrow buttons 47 for scrolling through a list of information displayed on the screen 44, and a selector button 46 may be included. The customizing device 26 may be powered by batteries mounted in the device or by a connection to a conventional electrical socket in the home.

Preferably, the electronic component 32 of the doll 30 and the customizing device 26 include an authentication code for limiting the toys that can be connected to the customizing device 26. A read-only memory (ROM) containing the authentication code may be included in the customizing device and the doll and the processor 37 may be programmed to transfer information to the doll 30 only if the ROM of the doll has an appropriate authentication code, or to otherwise prevent operation of the doll with the customizing device. The authentication code may comprise a series of bits representing a customer number, a randomly-generated number, any alphabetic, numeric or alphanumeric code or other data that can be used to confirm that the customizing device is authorized to access the database. The code may be stored in encrypted form in a ROM or a writable memory in the doll 30. One preferred method and device for device authentication is disclosed in U.S. Provisional Patent Application No. 60/210,504, filed Jun. 9, 2000, the disclosure of which is hereby incorporated by reference.

The central computer 12 allows customizing devices 26 to access the vendor's database. The vendor's database preferably comprises a database accessible only by purchasers of particular goods for sale by the vendor. Preferably, the customizing device 26 transmits the authentication code to the central computer 12. The central computer 12 is programmed to receive the authentication code and compare the same to a database or other table of authentication codes for toys sold by the vendor and/or designed for customization utilizing the vendor's system. If a valid authentication code is received by the central computer 12 from a customizing device 26, the central computer 12 transmits data to the customizing device 26. Data is preferably presented to the screen 44 on the user's customizing device 26 so that the user may select from a variety of options regarding customization of a toy such as the doll 30 shown in FIG. 1.

For example, the storage device 39 of the customizing device 26 preferably includes a program executable by processor 37 for transmitting the authentication code upon actuation of the selector button 46. After verifying that the authentication code is valid, the central computer transmits display data to the device 26 so that a display is generated on the screen 44. The display preferably includes a list of categories of customizing information which may be selected by the user. For example, a list of categories including educational, sports, adventure, comedy, mystery, etc. is displayed on screen 44. The screen 44 may be too small to display the entire list of categories, as shown in FIG. 3. The arrow buttons 47 may be utilized to scroll through the list and view all of the categories on the list. For example, a category may be highlighted when the user presses one of the arrow buttons 44. By pressing the down arrow button, the category beneath the initially highlighted category is highlighted. If the last category shown on the display 44 is highlighted (e.g., “adventure” in FIG. 3), and the user presses the down arrow button, the display scrolls down to include the next category from the display (e.g., “educational”). The user selects one of the categories by pressing the select button 46 while the desired category is highlighted. (FIG. 3). The user's selection is transmitted by the customizing device 26 over the internet to the central computer 12.

The user's selection of a category comprises a request to download customizing information to the customizing device 26. The user selects the category of customizing information of interest to the user for use with the toy 30. The customizing information comprises any information for customizing the doll. For example, the customizing information may comprise multimedia content, such as audio or video clips, stored in the customizing information database 21. The multimedia content preferably comprises a voice clip for playback by the speaker 52 on the customizing device 26 so as to produce speech. For example, the voice clip may produce a voice telling a story. Other customizing information includes commands for moving or changing the appearance of the doll 30. The user's selected category is transmitted by the customizing device 26 over the internet to the central computer 12.

Preferably, information concerning the user's request is incorporated into a personal profile previously created for the user by the central computer 12, as discussed further below. (See FIG. 3). The personal profile comprises a record in the profile database 16. The profile preferably includes registration information previously submitted by the user to the central computer 12. The profile also preferably includes request history information. The registration information and request history information reflect the preferences of the user. The registration information preferably includes information relating to the preferences of the user of the doll 30. For example, information regarding the user, including the user's name, color of eyes, favorite color, favorite cartoon character and favorite toys, is preferably included in the registration information. The registration information may also comprise the user's address, credit card or other billing information. The request history information comprises a record of the categories of customizing information requested by the user in the past. Preferably, the request history information also includes a record of the customizing information sent to the user in response to the user's request. The information concerning the user's present request is incorporated in the request history information of the profile database 16.

Certain information may also be stored on the customizing device 26, the microchip 33 of the doll 30, or both. For example, the user's selection of categories of customizing information may be stored on the microchip 33.

Upon receiving a request for customizing information from a customizing device 26, the central computer 12 searches the customizing information database 21 for information responsive to the user's request. The customizing information database 21 preferably comprises a multimedia content database having content such as video and/or audio clips for playback by the doll 30. The central computer 12 selects content responsive to the user's request and sends the requested multimedia content to the multiplexer 11 of the central computer 12.

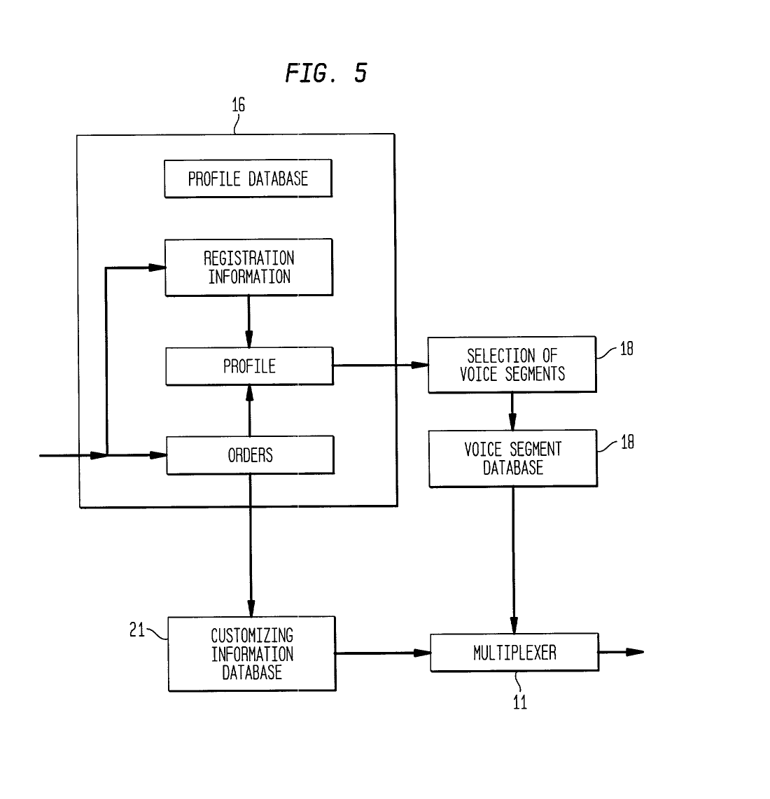

The central computer 12 searches the personalizing information database 18 for personalizing information based on the personal profile. Information from the personal profile is sent by the central computer 12 from the personal profile database to the personalizing information database 18. (FIG. 5). The personal profile is utilized as criteria for selecting personalizing information for the doll 30 of the user. The personalizing information may comprise information which is not requested by the user and information designed to be transferred to the doll 30 with customizing information requested by the user. The personalizing information is designed to be utilized by the customizing device 26 and electronic component 32 of the doll 30 so that the doll appears familiar with the user. The personalizing information may comprise voice segments or other audio clips for playback by the customizing device 26 and/or doll 30. The personalizing information may also comprise video content. The personalizing information database 18 preferably comprises a voice segment database 18. The voice segment database 18 utilizes information from the profile as criteria for selecting a voice segment from the voice segment database 19 according to the preferences and registration information contained in the personal profile. The personalizing information may be selected directly based upon information from the personal profile, or the personalizing information database 18 may be programmed to infer certain preferences of the user, based upon the user's age, gender, and other information. For example, assumptions regarding the user's school experiences and exposure to certain television programming, based upon the user's age and gender, can be applied in selecting information from the personalizing information database.

For example, the customizing information may comprise a voice clip for generating a voice telling a story through speaker 52. The personalizing information may comprise voice clips incorporated into the voice clip for telling the story so that the doll 30 appears familiar with the user. The personal profile may include the titles of the user's favorite books and the personalizing information may comprise voice clips incorporated into the story for referring to pictures included in the user's book corresponding to the story. The personalizing information may also comprise voice clips incorporated into a story for referring to the user's eye color, a user's pet, or favorite cartoon character, at appropriate locations within the story. The personalizing information database 18 and customizing information database 21 preferably contain digitized audio files. The files may comprise pulse code modulated (PCM) audio data compressed into a format that will transmit to the customizing device 26 efficiently.

The personalizing information is transferred to the multiplexer 11 of the central computer 12 by the voice segment database 18. The multiplexer 11 assembles the customizing information and the personalizing information for transmission over the Internet. Preferably, the customizing information comprises a plurality of audio files that are pieced together to form the story. The multiplexer 11 inserts the audio files comprising the personalizing information between predetermined audio files comprising customizing information. For example, the end of a first audio file represents an appropriate point in a story to refer to the user's eye color and the multiplexer 11 assembles the audio files so that personalizing information referring to the user's eye color follows the first audio file. Each audio file may include such information as is necessary for identifying the file's location within the story. After assembly by the multiplexer 11, the information including the customizing information and the personalizing information is sent to the customizing device 26 over the internet. The customizing device 26 receives information from the central computer 12. The information is stored on the storage device 39 of the customizing device 26. The user may then connect the doll 30 to the customizing device 26. The user inserts the plug 25 of the device 26 into the socket 36 on the doll 30. Preferably, the device 26 is programmed to automatically produce a display on the screen 44 that inquires whether the user would like to customize the doll 30. The user may press the selector button 46 on the device 26 to initiate customization of the doll. Alternatively, the device 26 may be programmed to automatically customize the doll 30 upon connection with the doll.

In customizing the doll, the customizing device 26 transfers information to the microchip 33 of the doll 30 through the plug 25 and socket 36. The information transferred to the toy is used so that the toy appears familiar with the user. Preferably, the information transferred to the doll includes at least some of the audio files transferred to the customizing device 26 and the microchip 33 accepts compressed audio files from the customizing device 26. For example, some or all of the audio files comprising the personalizing information may be transferred to the microchip 33 of the doll 30. The microchip 33 stores the compressed file for decompression by the processor 37 of the customizing device 26 and playback by the speaker 52. The information stored in the customizing device 26 contains data for playing or displaying content requested by the user. For example, where the user requested a story, the information transmitted to the customizing device 26 includes a voice clip which, when played, produces a voice telling a story. In producing the voice, the customizing device 26 utilizes the information stored in the microchip 33 of the doll 30. Each time the customizing device 26 customizes the doll 30, additional information is stored in the microchip 33. The customizing device preferably utilizes the information stored in the microchip 33 from previous customizing operations in playing customizing information and personalizing information so that the user grows accustomed to the doll 30 over time. Preferably, information such as information from the personal profile or information regarding the user's selection of customizing information is stored in microchip 33. If such information is stored, the customizing device 26 searches the microchip 33 for personalizing information and other information stored in the microchip 33 and such information may be used in playback of the customizing information.

The personalizing information contains information used for personalizing the doll. For example, the personalizing information may comprise a portion of the requested content, such as references to the user's eye color, pet, or teacher's name incorporated in a story. Anything the user is involved with may be incorporated into a story or otherwise utilized with the customizing information. In another example, the central computer 12 may use the profile to select the story requested by the user in the form of a voice clip generating a favorite T.V. character's voice telling the story. Additionally or alternatively, the personalizing information transmitted to customizing device 26 may comprise a voice clip greeting the user by name and telling the user information about a favorite cartoon character. The user may press the selector button 46 to play the customizing information and personalizing information through the speaker 52.

Desirably, the user enters registration information during a visit to a website provided by the vendor. After the user accesses the vendor's website, the central computer 12 preferably determines whether a personal profile for the user exists in the profile database 16. This may be accomplished by requiring that the user enter a log-in name upon accessing the website. The log-in names are included in the information in the profile database 16 and the log-in name for each user is associated with that user's profile information in the profile database. The central computer 12 then searches the profile database 16 for the log-in name. Alternatively, the central computer 12 assigns the user a user identification number, which is incorporated into the user's profile in the profile database 16. The user identification number may be saved on the hard drive of the user's personal computer. When a user accesses the website, the user identification number is transmitted to the central computer 12 and the central computer 12 searches the profile database 16. If the user's log-in name or identification number is found in the profile database 16, the user may update information on a registration form.

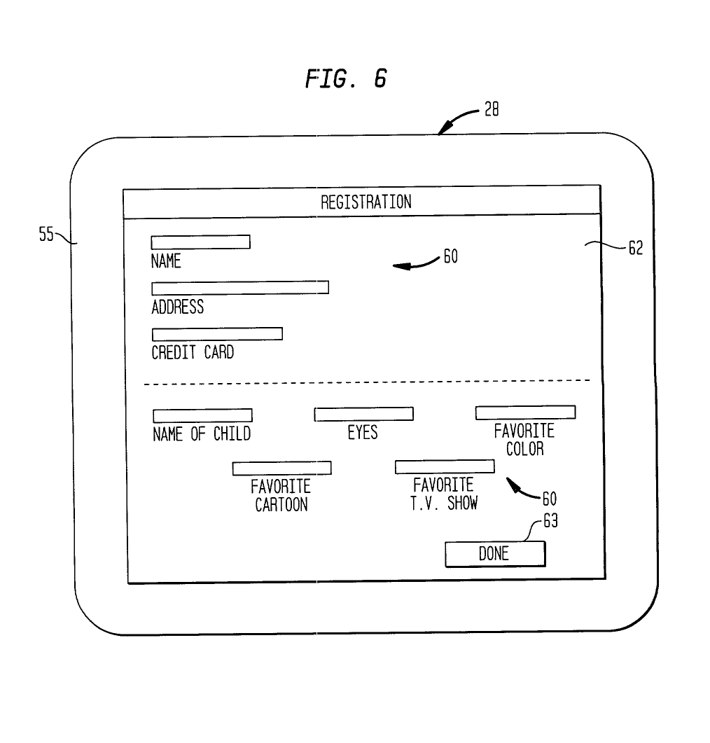

If there is no personal profile for the user in the profile database 16, the central computer 12 presents a registration form 62 comprising a display 55 having designated fields 60 for registration information to be entered by the user. (See FIG. 6). The form 62 includes registration information entered by the user. For example, the registration form 62 has fields 60 and the user enters information into the field 60 utilizing the keyboard and mouse of the user's personal computer. For example, the fields 60 may include the user's name, address, credit card or other billing information. In addition, the registration information preferably includes information relating to the preferences of the user of the doll 30. This information is also entered into the fields 60 of the registration form by the user. For example, information including the name, color of eyes, favorite color, favorite cartoon character and fields for other information is preferably included in the registration form to prompt the user to enter this information. In some cases, the user of the doll is a child and the user of the personal computer 25 is an adult and the adult enters the preferences of the child. In some cases, more than one child will be playing with the doll or other toys of the vendor. Thus, either personal profiles are created for each child or the personal profile includes more than one set of preferences.

Entry of information into certain of these fields may be required and others may be optional information. Required fields may be used to ensure that at least a minimum amount of information is provided by the user. If all required information is not entered, for example, the central computer 12 may reject the registration and present a display indicating missing information that must be provided before the order can be processed.

After the registration form 62 is completed, the user selects a button 63 on the display 55 that indicates that the user has completed the form 62 and initiates transfer of the registration information to the central computer 12. The central computer 12 creates a profile for the user in the profile database 16 and saves the registration information in the profile, as shown in (FIG. 5). In other preferred embodiments, a paper registration form may be filled out in writing by the user and mailed to the vendor of the doll. A registration form may be included with the customizing device 26 and/or doll 30 when purchased. Upon receipt of the form by the vendor, the registration information is entered into the profile database 16.

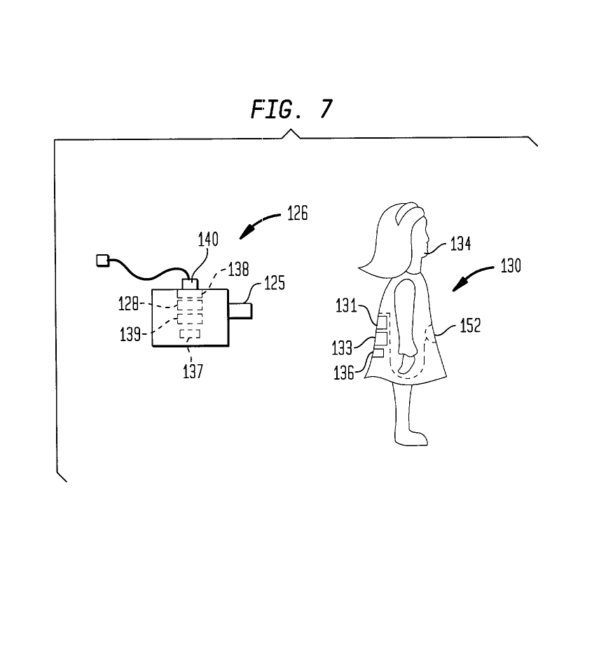

In another embodiment of the invention, the doll includes a speaker 152 for playing content received via the customizing device 126 (FIG. 7). The information is transmitted to the microchip 133 of the doll 130 by the customizing device. The information transferred to the microchip 133 may comprise the customizing information and personalizing information transferred to the customizing device 26. The doll 130 includes hardware, such as a RISC microprocessor (preferably, an “ARM” processor) 131 for playing customizing information and personalizing information through the speaker 152, from the microchip 133 of the doll 130, the storage device 139 of the customizing device 126, or both. The doll 130 may include as few electronic components as possible to simplify manufacture of the doll or modification of an existing doll. Alternatively or additionally, the doll may include as many electronic components necessary for operation partially or completely independently of the customizing device.

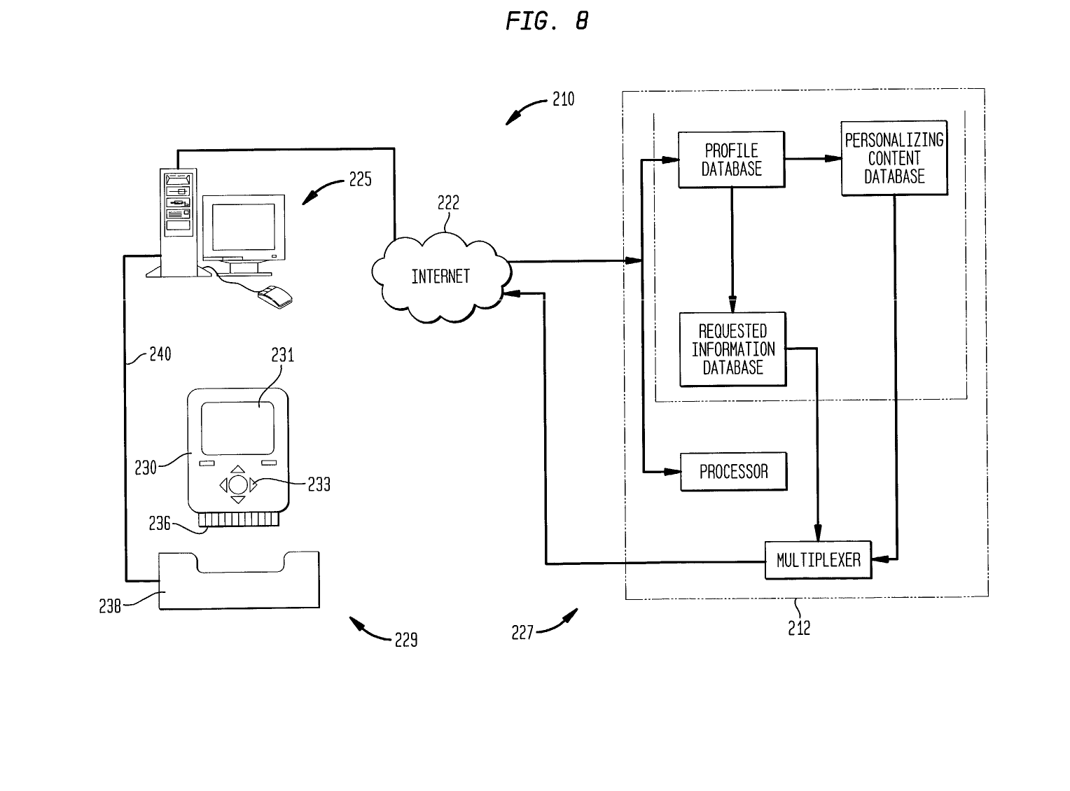

In a system in accordance with another embodiment of the invention shown in FIG. 8, the vendor end 227 of the system 210 may comprise a central computer 212, substantially as shown in FIG. 1. The central computer 212 is connected to the internet 222 for allowing personal computers such as personal computer 225 to access a website supported by the central computer 212. The user-end 229 includes a cradle 238 for connecting a hand-held videogame player 230 to the personal computer 250. The videogame player 230 includes the video screen 231 for displaying video content, such as games. The videogame player 230 includes input devices such as buttons 233 to enable a user to enter commands into the videogame player 230 to interact with a videogame and play the game. The videogame player 230 includes a connector 236 for forming an electrical connection with the cradle 238 that is connected to the personal computer 225 through line 240. The personal computer 225 may be utilized to access the central computer 212 of the vendor over the internet 222 and download information for the videogame player 230.

After downloading the information, the videogame player 230 is connected to the personal computer 225 through the cradle 238 and connector 236 on the videogame player 230. The personal computer 225 comprises a customizing device and is utilized to customize the videogame player 230. The information includes customizing information such as a game requested by the user and ordered from the central computer 232. Personalizing information is also downloaded with the requested game. For example, the personalizing information may comprise a voice clip which addresses the user of the videogame player 230 by name during use of the videogame. The voice clip may utilize the user's name or other personal information from the personal profile such as the age, hair color or eye color of the user of the videogame player. For example, a character within the videogame may be presented so as to appear to have the same hair and eye color as the user of the videogame. In another example, the personal profile includes information relating to the user's favorite place and the personalizing content includes a landscape representing the user's favorite place, as a feature of the videogame.

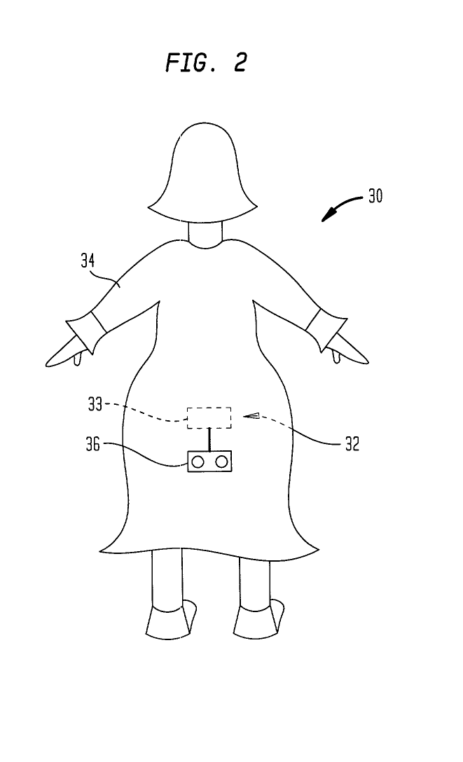

In other embodiments, the cradle comprises a customizing device, such as customizing device 26 discussed above in connection with FIGS. 1-6. The cradle includes a processor, storage device and modem for direct connection to the internet over a telephone wire. In other embodiments, a toy such as doll 30 receives information through a personal computer in place of, or used in addition to, the customizing device 26.

Utilizing the information, the toy can appear more animated. Through repeated updating of the profile in the profile database, utilizing subsequent orders for multimedia content or other customizing information, the toy can become more and more customized over time. The toy appears to learn about the user over time, so that the user develops a sense of a personal investment in the use of the toy and becomes more and more attached to it. As a personal computer, customizing device, or other device is utilized to download the content from the central computer, the processing occurs on the personal computer or device. Only a customizing interaction between the user's device and the toy is required to customize the toy.

In other embodiments, the customizing device may comprise a wireless internet interface instead of, or in addition to, the phone jack 41 and telephone wire discussed above. The customizing device includes software for connecting with a service provider utilizing a radio signal. The user uses the software to select a website. Information from the website, which has been transferred into a wireless application protocol, is transferred to the customizing device. In this way, the user communicates with the central computer 12, substantially as discussed above in connection with FIGS. 1-6. In other embodiments, the game player or personal computer discussed above in connection with FIG. 8 may be provided with a wireless connection to the internet for receiving customizing information.

In other embodiments, the central computer is accessed by the user by transmitting a request for customizing information via e-mail sent over the internet. The central computer receives the e-mail message and a human operator reviews the message, selects the customizing information and the personalizing information, compiles information to be sent to the user, and sends the information to the user via another e-mail message. The e-mail message may include an attachment comprising a compressed multimedia file, such as a voice clip. The user customizes the toy utilizing a personal computer.

In other preferred embodiments, the user's toy communicates with the customizing device or utilizing a short distance wireless interface. For example, each of the customizing device and toy of the user may include an infrared transmitter and receiver for sending and receiving information and to customize the toy. In certain preferred embodiments, the wireless interface comprises a short-range radio link, or other wireless interface technology. In other preferred embodiments, a device other than a toy may be customized. A cable T.V. console may be customized and the user may download content for customizing the display of their television set. In other embodiments, information broadcast to digital television receivers may be received by a customizing device and/or toy, which extracts the information for customizing the toy.

The system may utilize any computer network, such as a local area network, wide area network, client server network, or global computer information network. The computer-implemented method may also be implemented over the internet or an intranet. The steps of receiving information and the transmittal of information from the central computer may be performed by transmitting information over a communications system such as a telecommunications system, a cable TV system, or a satellite communications systems. The central computer may be operated by a vendor of dolls, game players, other toys, or any other electronic device. A user of an electronic device accesses the central computer of the vendor and customizes a toy or device. In customizing a toy or other device, personalizing information is transferred to the toy or device. The devices customized may include any electronic component or article incorporating an electronic component. The devices to be customized may include any portable or non-portable device.

Hardware for accomplishing a method in accordance with the invention, utilizing the computer systems discussed above, is known in the art. General purpose personal computers, network servers, computer components, electronic components, or any other devices now known or to be developed may be used to construct a system for implementing a method for allowing downloading of information for customizing devices of users.

The software for implementing the computer implemented method may include custom-designed software or preexisting software tools customized to create the computer system. For example, for the Internet, the interactive display at a user's personal computer is implemented utilizing an HTML, JAVA (TM of Sun Microsystems, Inc.), or C++ application transferred to a user's personal computer or web console. Protocols and languages are available for implementing a wireless connection to the internet, such as WAP protocol or IMODE. An HTML or JAVA application is executed on the user's personal computer or console. Those of ordinary skill in the art would be able to obtain, design, create and/or integrate the software and hardware necessary to carry out the method.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method of customizing a toy, comprising:
a) receiving at a remote location user information from a customizing device of a user; and
b) transmitting to said customizing device customizing information for customizing a toy of the user and personalizing information selected based upon a personal profile, said personalizing information being selected so that said toy appears familiar with the user after the user customizes said toy.

2. The method of claim 1, wherein the user information comprises a request to receive customizing information.

3. The method of claim 2, wherein the request is incorporated into the personal profile.

4. The method of claim 1, wherein information concerning the customizing information sent to the customizing device is incorporated into the personal profile.

5. The method of claim 1, further comprising the step of searching a customizing information database having multimedia content for customizing the toy.

6. The method of claim 5, further comprising selecting personalizing information comprising at least one voice clip, the at least one voice clip being selected based upon the personal profile so that the toy will appear familiar with the user.

7. The method of claim 1, wherein the personal profile comprises a record in a personal profile database consisting of information selected from the following: age, sex, movie preferences, television show preferences, cartoon character preferences, book preferences, color preferences, toy preferences, name preferences, address and billing information.

8. The method of claim 5, wherein the customizing information includes a voice clip for producing a voice telling a story.

9. The method of claim 5, wherein said customizing information includes a voice clip for producing a voice telling a story and said personalizing information comprises a voice clip incorporated into the story.

10. The method of claim 5, wherein said personalizing information comprises a voice clip for producing a voice commenting on personal information regarding the user as the story is told.

11. The method of claim 1, further comprising the step of assembling the customizing information and personalizing information before the step of transmitting.

12. The method of claim 11, wherein the customizing information comprises a plurality of audio files and the personalizing information comprises an audio file and the step of assembling includes inserting the file comprising personalizing information between predetermined files comprising customizing information.

13. A method of customizing a toy, comprising:
a) transferring information from a customizing device to a toy; and
b) storing said information in said toy, said information being selected so that said toy appears familiar with the user of the toy.

14. The method of claim 13, further comprising connecting the customizing device to the toy.

15. The method of claim 14, further comprising storing customizing information at the customizing device.

16. The method of claim 15, wherein said customizing information comprises a voice clip and further comprising playing the voice clip through a speaker of a customizing device.

17. The method of claim 16, wherein said voice clip is played while the customizing device is connected to the toy.

18. The method of claim 15, wherein said customizing information comprises a voice clip and further comprising playing the voice clip through a speaker of said toy.

19. The method of claim 15, further comprising selecting customizing information to be received at the customizing device.

20. The method of claim 19, further comprising storing on the customizing device the customizing information selected.

21. The method of claim 15, further comprising storing personalizing information at the customizing device with said customizing information.

22. The method of claim 21, further comprising storing said personalizing information on a storage device of the toy.

23. Apparatus for customizing a toy, comprising:
a) a computer having a first processor under control of programs and a first program executable by said first processor and adapted to receive requests from a user's customizing device at a remote location, and transmit to said customizing device customizing information for customizing the user's toy;
b) said first program being adapted to select and transmit to said customizing device personalizing information selected based upon a personal profile so that said toy appears familiar with the user after the user customizes the toy.

24. The apparatus of claim 23, wherein said first program is adapted to generate said personal profile based upon information submitted by the user.

25. The apparatus of claim 23, further comprising a customizing device.

26. The apparatus of claim 25, wherein the customizing device includes a second processor under control of programs and a second program executable by said second processor and adapted to receive said customizing information and personalizing information from said computer.

27. The apparatus of claim 26, wherein said customizing device comprises a personal computer.

28. The apparatus of claim 26, wherein said second processor is adapted to transmit information to the toy.

29. The apparatus of claim 25, wherein said customizing information comprises a voice clip.

30. The apparatus of claim 29, wherein said customizing device further comprises a speaker for playing said voice clip.

31. The apparatus of claim 29, wherein said information transferred to said toy comprises at least some of the customizing information and personalizing information transferred to said customizing device.

32. A customizing apparatus, comprising:
a) a customizing device having a first processor under control of programs and a first storage device having a first program for requesting customizing information for customizing a toy and receiving said customizing information and personalizing information; and
b) a toy adapted to receive information from said customizing device;
c) said personalizing information being selected based upon a personal profile so that said toy appears familiar with said user after said toy is customized.

33. The apparatus of claim 32, wherein said customizing information comprises a voice clip.

34. The apparatus of claim 33, wherein said customizing device comprises a speaker for playing said voice clip.

35. The apparatus of claim 31, wherein said toy comprises a socket for connecting said customizing device to said toy.

36. The apparatus of claim 32, wherein said toy comprises a speaker for playing said voice clip.

37. The apparatus of claim 31, wherein said first program comprises a program for receiving customizing information transmitted to said customizing device according to a wireless application protocol.

38. The apparatus of claim 31, wherein said first program comprises a program for receiving customizing information transmitted to said customizing device according to a hypertext transfer protocol.

39. The method of claim 31, wherein said toy comprises a doll.

40. The method of claim 31, wherein said toy comprises a game device having a second processor under control of programs and a second storage device having a second program for running software comprising a game.

41. The method of claim 40, wherein said customizing information comprises game software to be transferred to said game device.

42. The method of claim 41, wherein said personalizing information comprises an audio clip selected so that said game device appears familiar with the user.

43. The method of claim 42, wherein said profile includes preferences concerning game content.
